(19) United States
(12) Patent Application Publication
(10) Pub. No.: US 2019/0102654 A1
(43) Pub. Date: Apr. 4, 2019

(54) Generation of Training Data for Image Classification

(71) Applicant: Smoothweb Technologies Ltd., Hong Kong (HK)

(72) Inventor: Rajiv Trehan, London (GB)

(21) Appl. No.: 15/724,272

(22) Filed: Oct. 4, 2017

(51) Int. Cl. G06K 9/62; G06Q 10/08; G06K 9/00; G06K 9/78

(52) U.S. Cl. CPC G06K 9/6256; G06Q 10/087; G06N 3/08; G06K 9/78; G06K 9/6267; G06K 9/00671

(57) ABSTRACT

A system and methods for generating training images. The system includes a data processing system that performs object recognition and differentiation of similar objects in a retail environment. A method includes generating training images for neural networks trained for the Stock Keeping Unit (SKU), angle and gesture elements that allow multiple overlapping predictions function.

### FIELD OF THE INVENTION

The present invention relates to training data for neural networks and more particularly to generating training data for image classification for neural networks.

### BACKGROUND OF THE INVENTION

The image recognition has various aspects, such as the recognition of an object, the recognition of the appearance of a motion object, the prediction of the object in a case of the motion object. These recognitions have different task, for example feature extraction, image classification and generating training images using the classification. All these usage are very important.

Image processing now also use sophisticated neural networks to perform various tasks, such as image classification. Neural networks are configured through training images, which is known as training data. The training data is processed by train algorithms to find suitable weights for the neural networks. Thus, it is required that the neural network learn how to perform classification for new images by generalizing the data it learns in the training images.

However, the generation of training data is difficult and also prediction of the correct training data is still not with higher accuracy, because the images can include views of various objects from various perspectives and are also dependent on the angle of the image. The objects can be similar or different in size, shape, motion, or other characteristics. During human motion such as a walking process, it is difficult to perform recognition for human-motions, because the viewing angles of a camera are different and images are different.

As noted above, the object recognition has a very important role in the image classification. There are some systems and methods for image object recognition and image classification in the prior art.

Existing solutions for accurately identifying retail objects use RFID or BLE tagging to identify products. However, neither provides the ability to track an object in 3D so as to target different information to the consumer based on viewing angle. Further, RFID and BLE approaches do not consider the particular object being viewed out of a bag or collection of objects, for example, if someone is within a changing room, at best the consumer is required to place a given object of interest in close proximity to an antenna.

U.S. patent application Ser. No. 14/629,650 discloses a method and an apparatus for expressing a motion object. This is based on vision angle tracking, and falls short and requires complex hardware setups.

U.S. patent application Ser. No. 15/074,104 discloses object detection and classification across disparate fields of view. A first image generated by a first recording device with a first field of view, and a second image generated by a second recording device with a second field of view, can be obtained. An object detection component can detect a first object within the first field of view, and a second object within the second field of view. An object classification component can determine first and second level classification categories of the first object.

U.S. patent application Ser. No. 15/302,866 discloses a system for authenticating a portion of a physical object including receiving at least one microscopic image. Labelled data including at least one microscopic image of at least one portion of at least one second physical object associated with a class optionally based on a manufacturing process or specification is received. A machine learning technique including a mathematical function is trained to recognize classes of objects using the labeled data as training or comparison input, and the first microscopic image is used as test input to the machine learning technique to determine the class of the first physical object. The image recognition aims to replace RFID or BLE with a hybrid approach of using barcodes or images that simplify the recognition process. But again these do not address the angle tracking need.

China Patent No. CN106056141A discloses a target recognition and angle coarse estimation algorithm using space sparse coding.

China Patent application No. CN105938565A discloses a multi-layer classifier and Internet image aided training-based color image emotion classification method. However, object recognition using this image process technique falls short as they are complicated, tend not to work in real work environments such as stores or different consumer conditions such as different clothing.

None of the prior art provides identification of a product and the angle that the product is being viewed at so as to be able to provide specific meta-information including product features, endorsements, social media discussion, sponsorship, articles about the product and the viewing angle.

Further none of the prior art provides access to the meta-information in multiple languages using recognition based gestures.

Further none of the prior art provides an object recognition in different and changing environments, such as different store, with different varying background motion of other consumers and staff, different lighting, namely Hostile Environments.

Further none of the prior art able to differentiate very similar looking objects in which feature extraction would essentially provide undifferentiateble data.

Neural networks offer promise to solving these problems. However, many of the approaches for recognition under Hostile Environments involve extracting a feature set and then using such features as the training data for neural network. This can be seen extensively in face recognition, in which a normalized HOG based on image vector gradients is used to extract a feature set. However, this approach would not differentiate a given person under different make up conditions as could be considered the case when looking at different color variations of a given product model.

Therefore, there exists a need for an improved method and system for object recognition and differentiation of similar objects in a retail environment.

### SUMMARY OF THE INVENTION

In one aspect is directed to a method for object recognition and differentiation of similar objects in a retail environment. The method includes obtaining a stream of input images from a live camera feed, identifying an object of interest of known Stock Keeping Unit (SKU) in the stream of input images, tracking an angle of the object of interest with reference to the camera feed and directing contents based on gesture elements.

Further in one aspect, the object of interest means an object with a known Stock Keeping Unit (SKU).

Further in one aspect, a method for generating training images for neural networks trained for the Stock Keeping Unit (SKU), angle and gesture elements. The method includes generating training images set using base images groups with transparent backgrounds transposed onto a range of background images, identifying of Stock Keeping Unit (SKU) using base images and are grouped with respective to the Stock Keeping Unit (SKU), identifying of an angle of the object using base images, and are grouped with respective to the object angle and in order to direct the contents combining the Stock Keeping Unit (SKU), continual angle and gesture elements that allow multiple overlapping predictions function.

Further in one aspect, the base images are combined in various positions, sizes, and color filters that results in high accuracy in identifying the SKU in the stream of images.

Further in one aspect, a range of background images are used to train the neural networks.

Further in one aspect, for generating the training images, the Stock Keeping Unit (SKU) with the base images groups with transparent backgrounds are combined with background images in various positions, sizes, and color filters resulting in high accuracy in identifying the Stock Keeping Unit (SKU) in the stream of input images.

Further in one aspect, for generating the training images the angle overlapping with the respective base images groups with transparent backgrounds are combined with background images in various positions, sizes, and color filters that result in high accuracy in identifying the angle of object.

Further in one aspect, for generating the training images the position and the angle with base images groups with transparent backgrounds and are combined with background images in various sizes, color filters that results in high accuracy in identifying gesture elements.

Further in one aspect, the combination of the Stock Keeping Unit (SKU), the angle and the gesture elements allow multiple overlapping predictions function in order to direct the contents.

Further in one aspect, the neural networks direct the contents with respective meta-information associated with the input images, the meta-information includes but not limited to product features, endorsements, social media discussion, sponsorship, articles.

Further in one aspect, the meta-information is in multiple languages using recognition based object profile.

Further the neural network identifies the Stock Keeping Unit (SKU) within noisy environments. Further the neural network identifies Stock Keeping Unit (SKU) within the stream of input images. Further the neural network identifies the angle within noisy environments.

In another aspect, a method for tracking angle and Stock Keeping Unit (SKU) separately and then combining to provide the SKU angle combination. This is because the Stock Keeping Unit (SKU) is best determined for a side view. Once the Stock Keeping Unit (SKU) is identified, then tracking the angle can provide high accuracy in classification of the input images. Certain classifications will be very accurate.

In another aspect, a system for generating a training image is provided, the system comprising computer-executable programmed instructions for neural networks for generating the training images.

These and other aspects are discussed in detail below. The foregoing information and the following detailed description include illustrative examples of various aspects and implementations, and provide an overview for understanding the claimed aspects and implementations.

### BRIEF DESCRIPTION OF THE DRAWINGS

The following invention will be described with reference to the following drawings of which:

FIG. 1 is a functional diagram of a system capable of generating training data for image classification, according to an embodiment of the present invention;

FIG. 2 a flow diagram depicting an exemplary method of generating training data for image classification, according to an embodiment of the present invention;

FIG. 3a, FIG. 3b, FIG. 3c, FIG. 3d and FIG. 3f depict examples of Stock Keeping Unit (SKU), according to an embodiment of the present invention;

FIG. 4 depicts examples of background images, according to an embodiment of the present invention;

FIG. 5a. depicts an example of a Stock Keeping Unit (SKU) transposed onto background images, according to an embodiment of the present invention;

FIG. 5b. is depicts an example of a Stock Keeping Unit (SKU) transposed onto a range of background images, according to an embodiment of the present invention;

FIG. 6 are examples depicting Stock Keeping Units (SKU) transposed onto a range of background images, according to an embodiment of the present invention;

FIG. 7 depict examples of side view, angle view and front view of different Stock Keeping Units (SKU) transposed onto a background image, according to an embodiment of the present invention;

FIG. 8a, FIG. 8b and FIG. 8c are examples depicting side view, angle view and front view of different Stock Keeping Units (SKU) are transposed onto a background, according to an embodiment of the present invention;

FIG. 9 is an example depicting cross product of Stock Keeping Unit (SKU) of the base image groups with transparent backgrounds transposed onto a range of background images, according to an embodiment of the present invention; and

FIG. 10 is a block diagram illustrating a general architecture for a computer system that may be employed to implement elements of the systems and methods described and illustrated herein, according an embodiment of the present invention.

The drawing figures do not limit the present invention to the specific embodiments disclosed and described herein. The drawings are not necessarily to scale; emphasis instead is placed upon clearly illustrating the principles of the invention.

### DETAILED DESCRIPTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

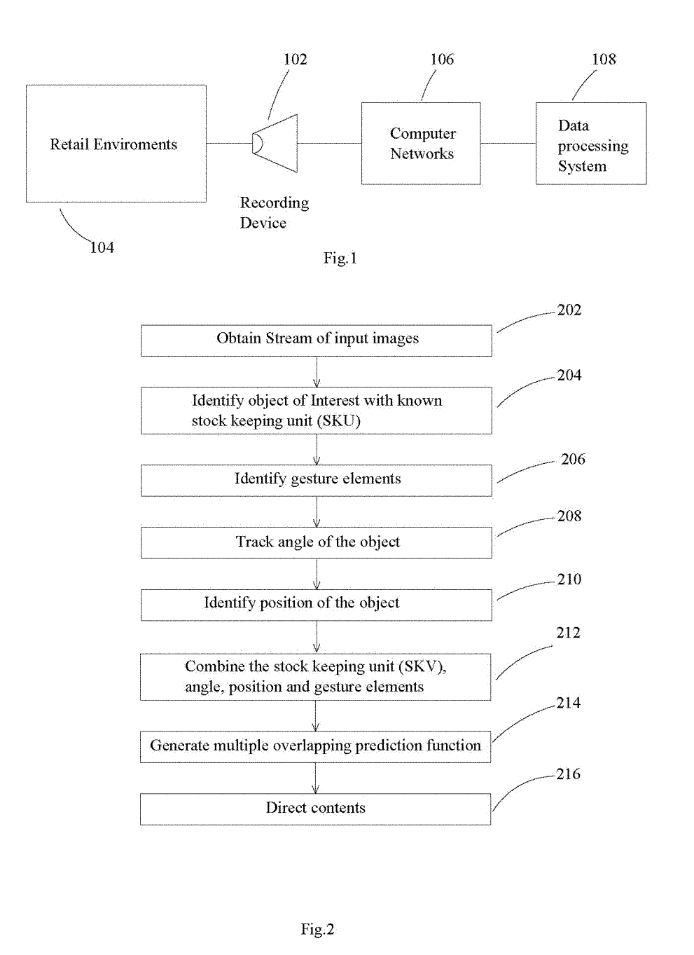

Following below are more detailed descriptions of systems and methods of Generation of training data for image classification. FIG. 1 illustrates an example system 100 for identifying objects across different fields of view. The system 100 can be part of obtaining stream of input images, identifying object of interest and generating training images. In particular, the system 100 is implemented in the retail environments 104 that identifies or tracks at least one object that appears in live camera feed.

The system 100 described herein includes a recording device 102 such as camera for capturing images, a computer network 106 is associated the recording device 100 that communicate with a data processing system 108. The data processing system 108 includes an object detection component (e.g., that includes hardware) that detects object of interest from the input image with known Stock Keeping Unit (SKU) and further includes other modules or functions for tracking position and angle of the object, within the fields of view of the respective input images and other information about objects.

In general, the object of interest in a stream of input images from a live camera feed (that is, an image capturing a scene in retail environments 104. Correspondingly, it is described herein that a training images set can be generated by performing one or more particular function such adjusting or changing positions, sizes, and color filters that results in high accuracy in identifying the object of interest.

In one embodiment, the data processing system 108 is operable to use one or more base image group, perform generation of training images to the base image, associate the classification data of each base image with the respective generated training image and store the generated image with classification data to the memory for neural networks.

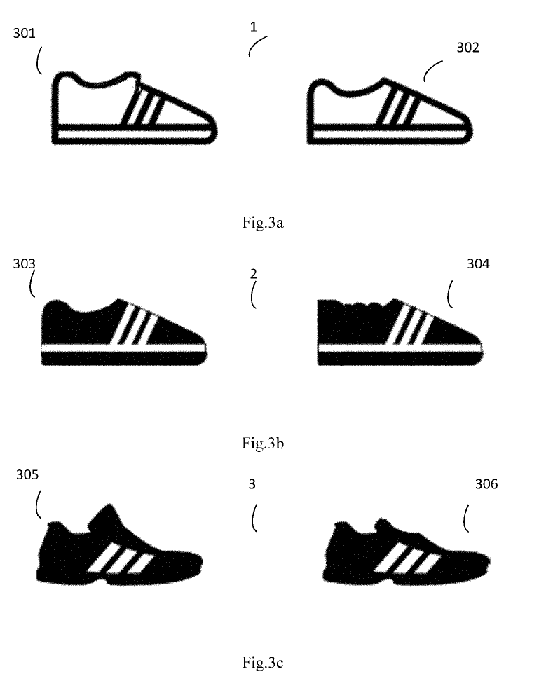

Referring now to FIG. 2, in another embodiment depicts an example method of generating training images. The method can obtain a stream of input images 202 from the recording device 102. The input images 202 can be obtained from the recording device 102 via the computer network 106 as described above. The input images 202 can be obtained in real time. The data processing system 108 that receives the input images 202 identify the Stock Keeping Unit (SKU) 204 of the object and also identify the gesture elements 206. Further tracks angle of the object 208 and position of the object 210. The data processing system 108 is configured with specific computer-executable programmed instructions for the neural networks. Further, the method can obtain base images groups with transparent backgrounds and generate training images sets for identifying of Stock Keeping Unit (SKU) using the base images and are grouped with respective to the Stock Keeping Unit (SKU). Further, the method generates training images sets for identifying of an angle of the object using base images, and are grouped with respective to the object angle and in order to direct the contents combine the Stock Keeping Unit (SKU), Angle and gesture elements 212 that allow multiple overlapping predictions function 214. Accordingly, in one embodiment, the method generates training images sets and directs the contents 216 by combining the base images in various positions, sizes, and color filters that result in high accuracy in identifying the angle of object.

Based for example on analysis of the base image obtained, the base images are combined in various positions, sizes, and color filters that results in high accuracy in identifying the Stock Keeping Unit (SKU) in the stream of images.

Further the neural networks are trained for identifying an object of interest of known Stock Keeping Unit (SKU) in the stream of input images, tracking an angle of the object of interest with reference to the camera feed and directing contents based on gesture elements.

In one embodiment, the angle overlapping with the respective base images groups with the transparent background are combined with background images in various positions, sizes, color filters that result in high accuracy in identifying the angle of object.

The method as discussed above provides tracking angle and Stock Keeping Unit (SKU) separately and then combining to provide the SKU angle combination. This is because the Stock Keeping Unit (SKU) is best determined for a side view. Once the Stock Keeping Unit (SKU) is identified, then tracking the angle can provide high accuracy in classification of the input images.

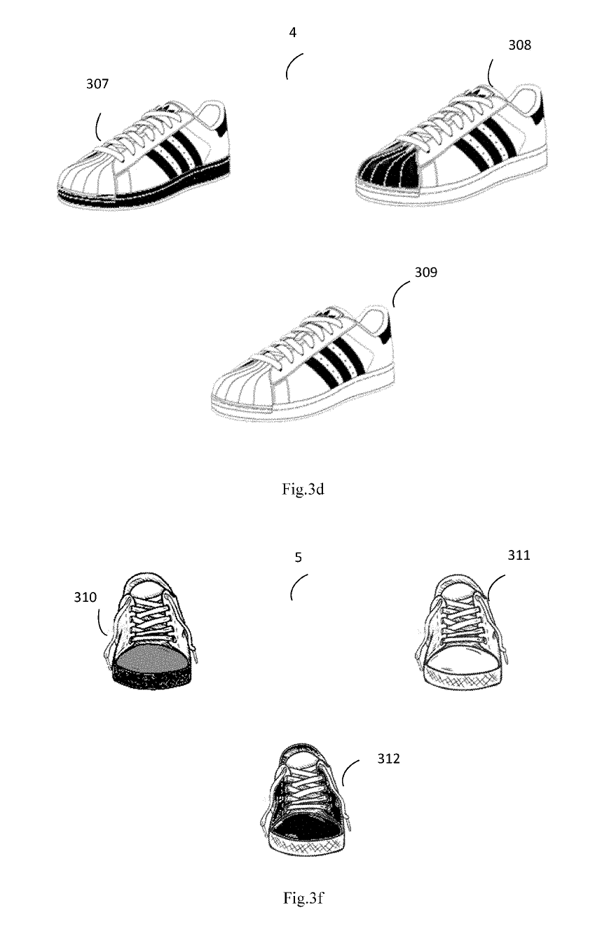

In one exemplary embodiment as shown in FIG. 3a, FIG. 3b, FIG. 3c, FIG. 3d and FIG. 3f, showing different base images for object of interests with known Stock Keeping Unit (SKU). For the exemplary illustrative, there are five types of Stock Keeping Unit (SKU) are shown, however there can be many more Stock Keeping Unit (SKU) depending upon the purpose and use. Objects 301 and 302 are first Stock Keeping Unit (SKU) 1, objects 303 and 304 are second Stock Keeping Unit (SKU) 2, objects 305 and 306 third Stock Keeping Unit (SKU) 3, objects 307, 308, and 309 are in forth Stock Keeping Unit (SKU) 4 and objects 310, 311, and 312 are fifth Stock Keeping Unit (SKU) 5. As described here, these are only set forth an example purpose without any loss of generality, and without imposing limitations.

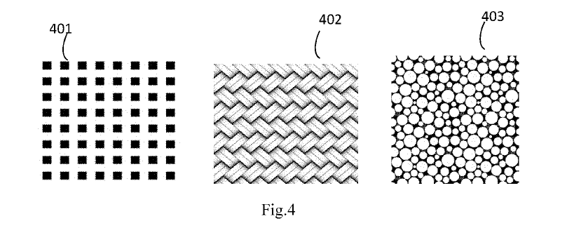

FIG. 4 depicts different background images 401, 402 and 403, there can be many background images without limiting the scope of the invention.

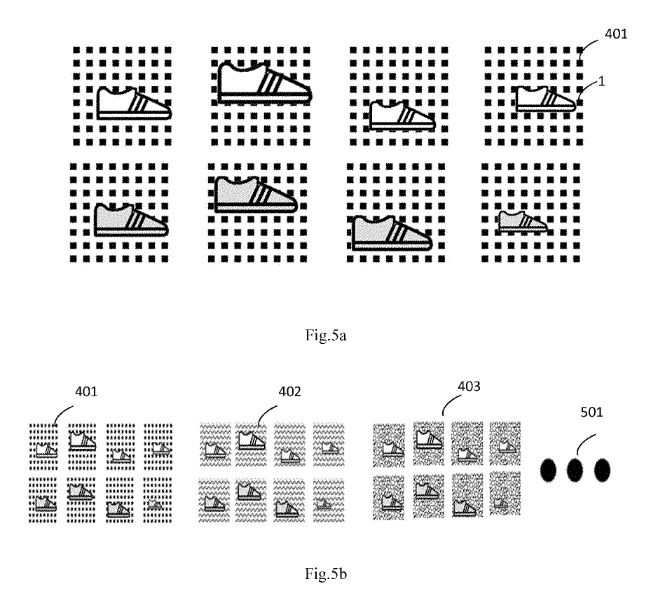

In one example, for generating training images, the first set of Stock Keeping Unit (SKU) 1 is transposed onto the background image 401 as shown in FIG. 5a. The base images are combined in various positions, sizes, and color filters that results in high accuracy in identifying the Stock Keeping Unit (SKU) in the stream of images. In one embodiment FIG. 5b shows how one Stock Keeping Unit (SKU) is combined with all backgrounds 401, 402, 403 to provide training set for identifying the Stock Keeping Unit (SKU). Further, the dotted line 501 means that the background images may be more other different types.

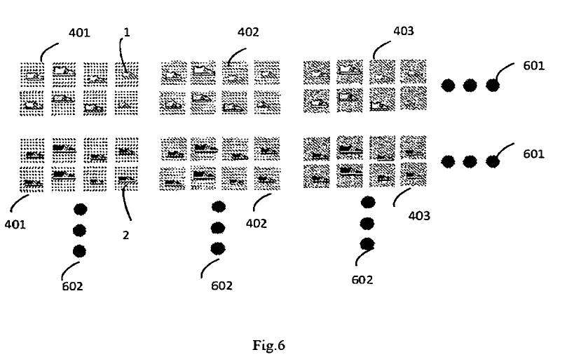

In one example, for generating training images, the Stock Keeping Units (SKU) 1, 2 are transposed onto each background image 401, 402 and 403 as shown in FIG. 6. As shown in the FIG. 6 provides training images to differentiate between the Stock Keeping Units in one embodiment. Further, the dotted line 601 means that the number of background images may be more without limiting scope of the invention, only three background images 401, 402 and 403 are illustrated for the exemplary purpose. Further, the dotted line 602 means that the number of Stock Keeping Units (SKU) may be more without limiting scope of the invention. Whereas shown in FIG. 6 is cross product of number of the Stock Keeping Units (SKU) with different background images. The base images are combined in various positions, sizes, color filters that results in high accuracy in identifying the Stock Keeping Unit (SKU) in the stream of images.

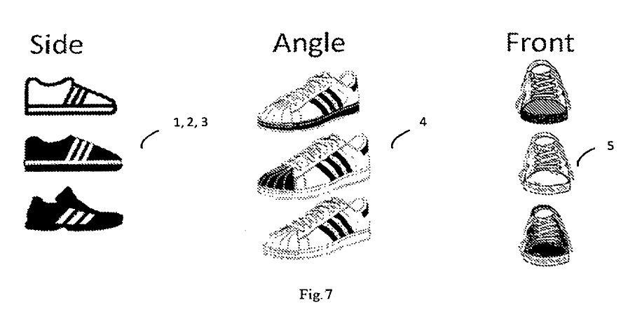

In one exemplary embodiment as shown in FIG. 7 illustrates side, angle and front of the base images of the Stock Keeping Units (SKU) 1, 2, 3, 4, and 5.

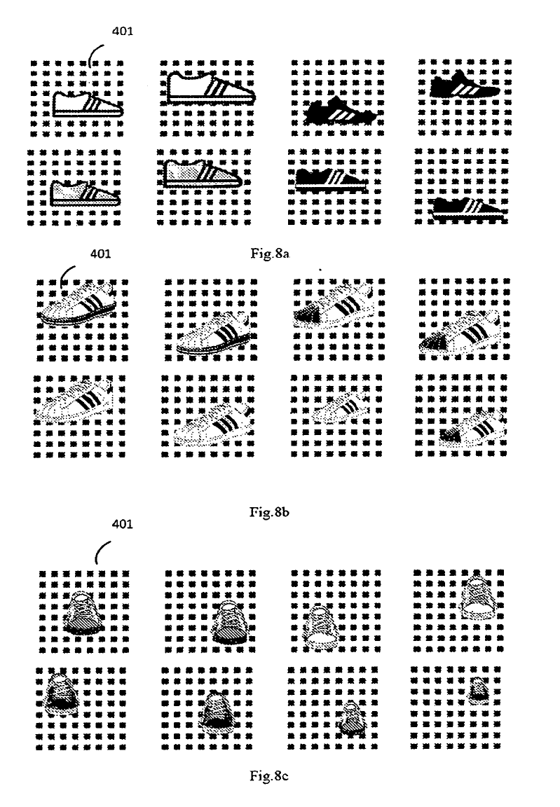

In one example, for generating training images, the side base image of the Stock Keeping Units (SKU) 1, 2 and 3 are transposed onto a background image 401 as shown in FIG. 8a.

Further, in another example, for generating training images, the angle base images of the fourth set of Angled images of a range of Stock Keeping Unit (SKU) 4 is combined onto the background image 401 as shown in FIG. 8b. The base images are combined in various positions, sizes, and color filters that results in high accuracy in identifying the Stock Keeping Unit (SKU) in the stream of images.

Similarly, for generating training images, the front base images of the fifth set of Front images of a range of Stock Keeping Unit (SKU) 5 is transposed onto the background image 401 as shown in FIG. 8c. The base images are combined in various positions, sizes, color filters that results in high accuracy in identifying the Stock Keeping Unit (SKU) in the stream of images.

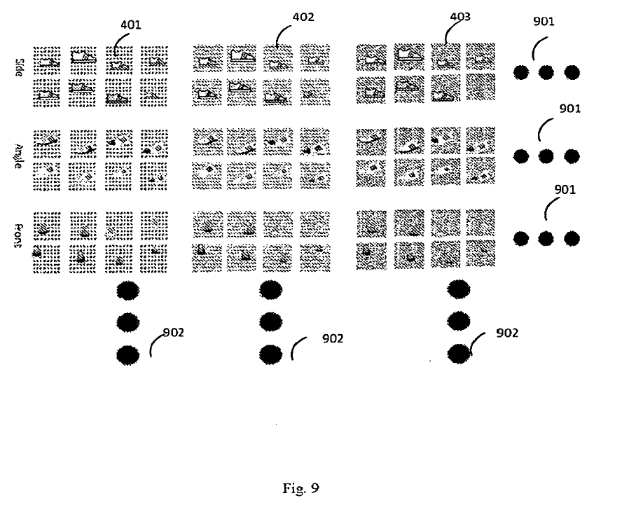

Again in FIG. 9, in one example, shows the cross product of generated training images, whereas the Stock Keeping Units (SKU) are for side, angle and front are transposed onto each background image 401, 402 and 403. The dotted line 901 means that the numbers of background images may be more without limiting the numbers of background images. Further, the dotted line 902 means that the numbers of Stock Keeping Units (SKU) may be more without limiting the numbers of Stock Keeping Units (SKU).

The described above are merely for examples in understanding of the invention without limiting the scope of invention. In one preferred embodiment, the present invention aims for generating training images by identifying of an angle of the object using base images, and are grouped with respective to the object angle and in order to direct the contents combining the Stock Keeping Unit (SKU), continual angle and gesture elements that allow multiple overlapping predictions function.

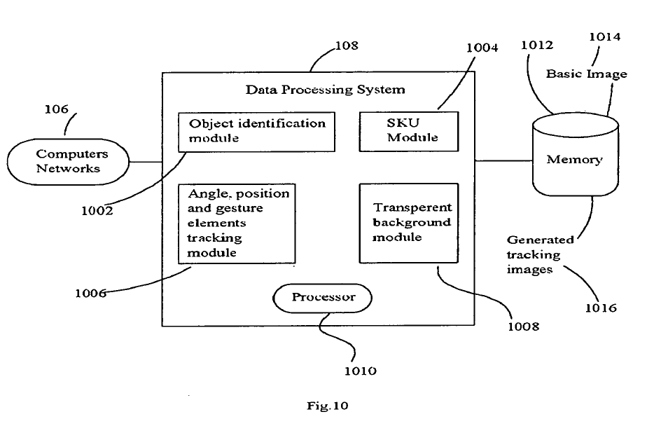

FIG. 10 illustrate an exemplary is a block diagram of general architecture for a computer system that may be employed to implement the system 100 of the present invention. The data processing system 108 is operable to perform various functions as described above. The data processing system 108 may comprises an object identification module 1002 that identify the object of interest, a Stock Keeping Unit (SKU) module 1004, a module for identifying an angle, position and gesture elements 1006 and a module including range of background image 1008. Further the data processing system 108 may further comprise a processor 1010 for performing all these function as described herein. A memory 1012 is linked to the data processing system 108 may further be provided for storing base images (also referred as existing training images) 1014 and for enabling the storage of generated training images 1016. Training images comprise meta-information including product features, endorsements, social media discussion, sponsorship, articles.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. Accordingly, the term “hardware module” should be understood to encompass a tangible entity, be that an entity that is physically configured to operate in a certain manner and/or to perform certain operations described herein. The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network.

One skilled in the art will appreciate that the embodiments provided above are exemplary and in no way limit the present invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such features may be combined with one or more other features of the other implementations as may be desired and advantageous for any given or particular application.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A computer-implemented method of object recognition and differentiation of similar objects in a retail environment, the method comprising:
in a hardware computing device configured with specific computer-executable programmed instructions;
obtaining a stream of input images from a live camera feed,
looking for an object of interest in the stream of input images, the object of interest means an object with a known Stock Keeping Unit (SKU),
tracking an angle of the object of interest with reference to the camera feed, said angle of the object of interest within the stream of input images identifies gesture to direct contents, and use of multiple neural networks trained for the Stock Keeping Unit (SKU), angle and gesture elements for generating training images, the generating comprising:
generating training images set using base images groups with transparent backgrounds transposed onto a range of background images;
generating training images sets for identifying of Stock Keeping Unit (SKU) using base images and are grouped with respective to the Stock Keeping Unit (SKU), where the base images are combined in various positions, sizes, and color filters that results in high accuracy in identifying the Stock Keeping Unit (SKU) in the stream of images;
generating training images sets for identifying of an angle of the object using base images, and are grouped with respective to the object angle, where the base images are combined in various positions, sizes, color filters that results in high accuracy in identifying the SKU in the stream of images; and
generating training images sets for identifying of a position of the object in the input image stream using base images and are grouped respective to the position, where the base images are combined in various sizes, and color filters that results in high accuracy in identifying the position in the stream of images,
wherein, in order to direct the contents combining the Stock Keeping Unit (SKU), continual Angle and gesture elements that allow multiple overlapping predictions function.

2. The method of claim 1, wherein the range of background images are used to train the neural networks.

3. The method of claim 1, wherein the neural networks are highly sensitive to identification of the base images group.

4. The method of claim 1, wherein the training images using Stock Keeping Unit (SKU) with base images groups with transparent backgrounds and are combined with background images in various positions, sizes, color filters resulting in high accuracy in identifying the Stock Keeping Unit (SKU) in the stream of input images

5. The method of claim 1, wherein the training images using the angle overlapping with the respective base images groups with the transparent background and are combined in various positions, sizes, and color filters that result in high accuracy in identifying the angle of object.

6. The method of claim 1, wherein the training image using the position and the angle with base images groups with transparent background and are combined with background images in various sizes, color filters that results in high accuracy in identifying gesture elements;

7. The method of claim 1, wherein the gesture elements identifying the gesture.

8. The method of claim 1, wherein the combination of the Stock Keeping Unit (SKU), the angle and the gesture elements allow multiple overlapping predictions function in order to direct the contents.

9. The method of claim 1, wherein the neural networks classifies each input image comprises data representing sizes having a respective size.

10. The method of claim 1, wherein the neural networks direct the contents with respective meta-information.

11. The method of claim 10, wherein the meta-information includes but not limited to product features, endorsements, social media discussion, sponsorship, articles.

12. The method of claim 11, wherein the meta-information is in multiple languages using recognition based object profile.

13. The method of claim 1, wherein the neural network identifying Stock Keeping Unit (SKU) within noisy environments.

14. The method of claim 1, wherein the neural network identifying Stock Keeping Unit (SKU) within the stream of input images.

15. The method of claim 1, wherein the neural network identifying the angle within noisy environments.

16. The method of claim 1, wherein using the same backgrounds set and same range of object locations, sizes, tints for each object of interest in the classification set to generate the training image, as a result the trained network becomes robust to background noise and focused on high accuracy in identifying the objects of interest in the stream or the images.

17. The method of claim 1, wherein the base images groups with transparent backgrounds are combined with background images that include images of people's legs and apparel alternatives to further eliminate those elements from the final trained weights and resulting classification.

18. A computer-implemented system configured with specific computer-executable programmed instructions for neural networks, cause to perform operations comprising:
obtaining a stream of input images from a live camera feed;
identifying an object of interest in the stream of input images, the object of interest means an object with a known Stock Keeping Unit (SKU),
tracking an angle of the object of interest with reference to the camera feed, said angle of the object of interest within the stream of input images identifies gesture to direct contents, and generating training images set using base images groups with transparent backgrounds transposed onto a range of background images, the generating comprising;
generating training images sets for identifying of Stock Keeping Unit (SKU) using base images and are grouped with respective to the Stock Keeping Unit (SKU), where the base images are combined in various positions, sizes, and color filters that results in high accuracy in identifying the Stock Keeping Unit (SKU) in the stream of images;
generating training images sets for identifying of an angle of the object using base images, and are grouped with respective to the object angle, where the base images are combined in various positions, sizes, and color filters that results in high accuracy in identifying the SKU in the stream of images; and
generating training images sets for identifying of a position of the object in the input image stream using base images and are grouped respective to the position, where the base images are combined in various sizes, and color filters that results in high accuracy in identifying the position in the stream of images,
wherein, in order to direct the contents combining the Stock Keeping Unit (SKU), continual angle and gesture elements that allow multiple overlapping predictions function.

19. The system of claim 18, wherein the training images using Stock Keeping Unit (SKU) with base images groups with the transparent background and are combined with background images in various positions, sizes, and color filters resulting in high accuracy in identifying the Stock Keeping Unit (SKU) in the stream of input images

20. The system of claim 18, wherein the training images using the angle overlapping with the respective base images groups with the transparent background are combined in various positions, sizes, and color filters that result in high accuracy in identifying the angle of object.

21. The system of claim 18, wherein the neural networks direct the contents with respective meta-information.

22. The system of claim 18, wherein the meta-information includes but not limited to product features, endorsements, social media discussion, sponsorship, articles.
